(19) United States
(12) Patent Application Publication
(10) Pub. No.: US 2014/0334090 A1
(43) Pub. Date: Nov. 13, 2014

(54) HIGH FLOW REINFORCED POLYIMIDE COMPOSITIONS WITH VERY LOW RESIDUAL CONTAMINATION FOR HARD DISK DRIVE ENCLOSURE

(71) Applicant: SABIC INNOVATIVE PLASTICS IP B.V. et al, Bergen op Zoom (NE)

(72) Inventors: Gary Shen, Shanghai (CN); Yangang Yan, Shanghai (CN)

(73) Assignee: SABIC INNOVATIVE PLASTICS IP B.V. et al, Bergen op Zoom (NE)

(21) Appl. No.: 13/884,677

(22) PCT Filed: Dec. 31, 2012
(86) PCT No.: PCT/CN2012/088057

§ 371 Date: May 10, 2013

(51) Int. Cl. C08L 79/08; G06F 1/18

(52) U.S. Cl. CPC C08L 79/08; G06F 1/181; C08L 2203/206; C08L 2205/12; C08L 2205/03
USPC 361/679.33; 524/538; 312/223.2; 428/337

(57) ABSTRACT

A filled polymeric composition of high flowability suitable for thin wall (<1 mm thickness) molding, the composition including (a) from 10 to 50 wt % of a reinforcing filler; (b) from 1 to 10 wt % of a polyamide or from 5 to 20 wt % of a liquid crystal polymer (LCP) as a flow promoter; and the balance being a polyetherimide (PEI) resin. Composites including an injection molded substrate having a thickness of 0.4-0.8 mm, formed of the composition, and at least one coating thereon. The coating can be a metal or an acrylate coating.

### BACKGROUND OF THE INVENTION

1. Field of the Invention

The invention relates generally to high flow reinforced polyimide compositions and more specifically to high flow reinforced polyimide compositions having cleanliness suitable for hard disk drive enclosures.

2. Description of the Related Art

High performance (high heat) polyimide polymers, i.e. polymers having a glass transition temperature (Tg) of greater than or equal to 180° C., with filler compositions can be applied in the manufacture of molded articles for metal replacement applications, e.g., hard disc drive (HDD), with good mechanical properties, excellent dimensional stability at elevated temperatures. To meet all the performance requirements, at least a certain amount of fillers must be introduced into the resins. In the meantime, such compositions are required to possess excellent cleanliness on the outgassing, leachable ion chromatography (IC), liquid particle counting (LPC), and non-volatile residue (NVR) performance on the final part. However, as shown in the examples presented herein, filler reinforced high performance polymer parts can exhibit lower flow-ability for thin wall molding, i.e., moldings having a thickness that is <1 mm.

Therefore, a need exists for a new glass fiber (GF) filled polyimide composites with a flow promoter component selected from a group of polyamides, liquid crystal polymers, and combinations thereof to achieve thin wall part molding for HDD enclosure.

### BRIEF SUMMARY OF THE INVENTION

In order to provide filled polyimide composites with polyamide and liquid crystal polymer as the flow promoter and to achieve thin wall part molding for HDD enclosure, various types of glass, including flat fiber and glass flake can be introduced into the composites to control the dimensional stability, shrinkage and warpage of the molded part. Furthermore, a metallization method and coating process can be conducted on the polyimide substrate to improve the cleanliness performance on outgassing, leachable IC, LPC, NVR with all the performances well retained.

### DETAILED DESCRIPTION OF THE INVENTION

Our invention is based, in part, on the observation that it is now possible to make filled polymeric polyetherimide composition of high flowability suitable for thin wall (<1 mm thickness) articles by using a specific combination of reinforcing fillers and a flow promoter component selected from the group of polyamides and liquid crystal polymers (LCP). Compositions of our invention can exhibit excellent flow properties and useful combination of physical properties such as high heat distortion temperatures, high flexure modulus, high tensile strength and high notched impact properties. The compositions of our invention can be used to make composites useful in the consumer electronic applications such as hard disk drive composite enclosures.

The present invention may be understood more readily by reference to the following detailed description of preferred embodiments of the invention as well as to the examples included therein. All numeric values are herein assumed to be modified by the term “about,” whether or not explicitly indicated. The term “about” generally refers to a range of numbers that one of ordinary skill in the art would consider equivalent to the recited value (i.e., having the same function or result). In many instances, the term “about” may include numbers that are rounded to the nearest significant figure.

One embodiment relates to a filled polymeric composition of high flowability suitable for thin wall (<1 mm thickness) molding, the composition can include from 10 to 50 percent by weight of a reinforcing filler; from 1 to 10 percent by weight of a polyamide or from 5 to 20 percent by weight of a liquid crystal polymer (LCP) as a flow promoter; and, the balance being a polyetherimide (PEI) resin.

The composition can include a reinforcing filler within a range having a lower limit and/or an upper limit. The range can include or exclude the lower limit and/or the upper limit. The lower limit and/or upper limit can be selected from 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, and 60 wt. %. For example, according to certain preferred embodiments, the composition can include a reinforcing filler in an amount of from 10 to 50 percent by weight based on the total weight of the composition.

The composition can include a polyamide flow promoter within a range having a lower limit and/or an upper limit. The range can include or exclude the lower limit and/or the upper limit. The lower limit and/or upper limit can be selected from 0, 1, 2, 3, 4, 5, 6, 7, 8, 9, 10, 11, 12, 13, 14, 15, 16, 17, 18, 19, and 20 wt. %. For example, according to certain preferred embodiments, the composition can include a polyamide flow promoter in an amount of from 1 to 10 percent by weight based on the total weight of the composition.

The composition can include a liquid crystal polymer flow promoter within a range having a lower limit and/or an upper limit. The range can include or exclude the lower limit and/or the upper limit. The lower limit and/or upper limit can be selected from 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, and 30 wt. %. For example, according to certain preferred embodiments, the composition can include a liquid crystal polymer flow promoter in an amount of from 5 to 20 percent by weight based on the total weight of the composition.

The composition can include a polyetherimide (PEI) resin within a range having a lower limit and/or an upper limit. The range can include or exclude the lower limit and/or the upper limit. The lower limit and/or upper limit can be selected from 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, and 90 wt. %. For example, according to certain preferred embodiments, the composition can include a polyetherimide (PEI) resin in an amount of from 10 to 90 by weight based on the total weight of the composition

According to various embodiments, the composition can exhibit a linear flow during injection molding and a capillary viscosity that is lower than a reinforced polyimide resin without from 1 to 10 wt % of a polyamide flow promoter and without from 5 to 20 wt % of a liquid crystal polymer (LCP) flow promoter within a range having a lower limit and/or an upper limit. The range can include or exclude the lower limit and/or the upper limit. The lower limit and/or upper limit can be selected from 5, 10, 15, 20, 25, 30, 35, 40, 45, 50, 55, 60, 65, 70, 75, 80, 85, 90, 95, and 100%. For example, according to certain preferred embodiments, according to various embodiments, the composition can exhibit a linear flow during injection molding and a capillary viscosity that is lower than a reinforced polyimide resin without from 1 to 10 wt % of a polyamide flow promoter and without from 5 to 20 wt % of a liquid crystal polymer (LCP) flow promoter by an amount of at least 25%.

According to various embodiments, the composition can exhibit a shear rate within a range having a lower limit and/or an upper limit. The range can include or exclude the lower limit and/or the upper limit. The lower limit and/or upper limit can be selected from 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, and 200 pa-s at 5000 l/s and at 360° C. For example, according to certain preferred embodiments, according to various embodiments, the composition can exhibit a shear rate of lower than 150 pa-s at 5000 l/s and at 360° C.

According to various embodiments, the reinforcing filler can be one selected from the group consisting of glass fiber, glass flake, flat glass fiber, and combinations thereof. In one embodiment, mixtures of glass flakes and flat glass fibers can be used.

According to various embodiments the glass fiber can have a cross-sectional diameter within a range having a lower limit and/or an upper limit. The range can include or exclude the lower limit and/or the upper limit. The lower limit and/or upper limit can be selected from 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, and 20.5 μm. For example, according to certain preferred embodiments, according to various embodiments the glass fiber can have a cross-sectional diameter of from 8.5 to 12.5 μm or of about 11 μm.

According to various embodiments the flat fiber can have a cut length within a range having a lower limit and/or an upper limit. The range can include or exclude the lower limit and/or the upper limit. The lower limit and/or upper limit can be selected from 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, and 5 mm.

For example, according to certain preferred embodiments, according to various embodiments the flat fiber can have a cut length of about 3 mm.

The flat fiber can comprise a urethane silane finish or epoxy silane finish.

The flat fiber can have a cross sectional length within a range having a lower limit and/or an upper limit. The range can include or exclude the lower limit and/or the upper limit. The lower limit and/or upper limit can be selected from 2, 4, 6, 8, 10, 12, 14, 16, 18, 20, 22, 24, 26, 28, 30, 32, 34, 36, 38, 40, 42, 44, 46, 48, 50, 52, 54, 56, 58, and 60 μm. For example, according to certain preferred embodiments, the flat fiber can have a cross sectional length of about 28 μm.

The flat fiber can have a cross-sectional height within a range having a lower limit and/or an upper limit. The range can include or exclude the lower limit and/or the upper limit. The lower limit and/or upper limit can be selected from 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, and 20 μm. For example, according to certain preferred embodiments, the flat fiber can have a cross-sectional height of about 7 μm.

According to various embodiments, the glass flake can have an average particle diameter within a range having a lower limit and/or an upper limit. The range can include or exclude the lower limit and/or the upper limit. The lower limit and/or upper limit can be selected from 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, and 600 μm. For example, according to certain preferred embodiments, according to various embodiments, the glass flake can have an average particle diameter of from 160-500 μm.

The glass flake can have an average thickness within a range having a lower limit and/or an upper limit. The range can include or exclude the lower limit and/or the upper limit. The lower limit and/or upper limit can be selected from 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.5, 6, 6.5, 7, 7.5, 8, 8.5, 9, 9.5, and 10 μm. For example, according to certain preferred embodiments, the glass flake can have an average thickness of from 0.7-5 μm.

The glass flake can have a particle diameter distribution, such that less than 20% of the glass flakes have an average particle diameter of greater than 1.4 mm; greater than 60% of the glass flakes have an average particle diameter of from 0.5-1.4 mm; and 20% of the glass flakes have an average particle diameter of less than 0.15 mm.

According to various embodiments, the polyamide flow promoter can be one selected from the group consisting of nylon 6, nylon 66, polyphthalamide, and combinations thereof.

According to various embodiments, the liquid crystal polymer can include a high-melting point thermoplastic selected from the group consisting of co-polyester, co-polyesteramides, multiple half or wholly aromatic polyesters and combinations thereof.

According to various embodiments, the composition can have a heat distortion temperature (HDT) within a range having a lower limit and/or an upper limit. The range can include or exclude the lower limit and/or the upper limit. The lower limit and/or upper limit can be selected from 150, 160, 170, 180, 190, 200, 210, 220, 230, 240, 250, 260, 270, 280, 290, 300, 310, 320, 330, 340, 350, 360, 370, 380, 390, and 400° C. For example, according to certain preferred embodiments, according to various embodiments, the composition can have a heat distortion temperature (HDT) higher than 180° C.

According to various embodiments, the composition can have a flexure modulus within a range having a lower limit and/or an upper limit. The range can include or exclude the lower limit and/or the upper limit. The lower limit and/or upper limit can be selected from 7500, 7600, 7700, 7800, 7900, 8000, 8100, 8200, 8300, 8400, 8500, 8600, 8700, 8800, 8900, 9000, 9100, 9200, 9300, 9400, 9500, 9600, 9700, 9800, 9900, 10000, 10100, 10200, 10300, 10400, 10500, 10600, 10700, 10800, 10900, 11000, 11100, 11200, 11300, 11400, 11500, 11600, 11700, 11800, 11900, 12000, 12100, 12200, 12300, 12400, 12500, 12600, 12700, 12800, 12900, 13000, 13100, 13200, 13300, 13400, 13500, 13600, 13700, 13800, 13900, 14000, 14100, 14200, 14300, 14400, 14500, 14600, 14700, 14800, 14900, 15000, 15100, 15200, 15300, 15400, 15500, 15600, 15700, 15800, 15900, 16000, 16100, 16200, 16300, 16400, 16500, 16600, 16700, 16800, 16900, 17000, 17100, 17200, 17300, 17400, 17500, 17600, 17700, 17800, 17900, 18000, 18100, 18200, 18300, 18400, 18500, 18600, 18700, 18800, 18900, 19000, 19100, 19200, 19300, 19400, 19500, 19600, 19700, 19800, 19900, and 20000 MP. For example, according to certain preferred embodiments, according to various embodiments, the composition can have a flexure modulus higher than 8,000 MP.

According to various embodiments, the composition can have a tensile strength within a range having a lower limit and/or an upper limit. The range can include or exclude the lower limit and/or the upper limit. The lower limit and/or upper limit can be selected from 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, and 300 Mpa. For example, according to certain preferred embodiments, according to various embodiments, the composition can have a tensile strength higher than 100 Mpa.

According to various embodiments, the composition can have a IZOD notched impact strength within a range having a lower limit and/or an upper limit. The range can include or exclude the lower limit and/or the upper limit. The lower limit and/or upper limit can be selected from 40, 45, 50, 55, 60, 65, 70, 75, 80, 85, 90, 95, 100, 105, 110, 115, 120, 125, 130, 135, 140, 145, and 150 J/m. For example, according to certain preferred embodiments, according to various embodiments, the composition can have a IZOD notched impact strength higher than 50 J/m.

Other embodiments relate to a composite. The composite can include a molded substrate, e.g., an injection molded substrate, formed of the composition described with respect to the other embodiments, such as a filled polymeric composition of high flowability suitable for thin wall (<1 mm thickness) molding, the composition can include from 10 to 50 percent by weight of a reinforcing filler; from 1 to 10 percent by weight of a polyamide or from 5 to 20 percent by weight of a liquid crystal polymer (LCP) as a flow promoter; and, the balance being a polyetherimide (PEI) resin. The injection molded substrate can have a thickness within a range having a lower limit and/or an upper limit. The range can include or exclude the lower limit and/or the upper limit. The lower limit and/or upper limit can be selected from 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, and 1 mm. For example, according to certain preferred embodiments, an injection molded substrate can have a thickness of from 0.4-0.8 mm.

The composite can further include at least one coating disposed on or adhered to the filled polymeric composition. The coating selected from the group consisting of a metal and an acrylate coating. According to some embodiments, the composite can include both an acrylate coating and a metal coating. The acrylate coating can lie between the substrate and the metal. The metal coating can lie between the substrate and the acrylate coating. The metal can be Ni. The metal can be a sputtered metal.

According to various embodiments the composite can be in the form of an HDD enclosure. The composite can be a disk drive enclosure enclosing at least one surface of the disk.

According to various embodiments the composite can have a liquid particle counter value within a range having a lower limit and/or an upper limit. The range can include or exclude the lower limit and/or the upper limit. The lower limit and/or upper limit can be selected from 100, 200, 300, 400, 500, 600, 700, 800, 900, 1000, 1100, 1200, 1300, 1400, 1500, 1600, 1700, 1800, 1900, and 2000 particles/cm². For example, according to certain preferred embodiments, according to various embodiments the composite can have a liquid particle counter value less than 1,500 particles/cm².

According to various embodiments the composite can have a warpage on a top cover of the HDD enclosure within a range having a lower limit and/or an upper limit. The range can include or exclude the lower limit and/or the upper limit. The lower limit and/or upper limit can be selected from 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, and 400 μm. For example, according to certain preferred embodiments, according to various embodiments the composite can have a warpage on a top cover of the HDD enclosure of less than 350 μm.

According to various embodiments the composite can have a low outgassing detect at 85° C., such that the total organic carbon (TOC) detected by GC-MS is within a range having a lower limit and/or an upper limit. The range can include or exclude the lower limit and/or the upper limit. The lower limit and/or upper limit can be selected from 100, 200, 300, 400, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, and 3500 ng/cm². For example, according to certain preferred embodiments, according to various embodiments the composite can have a low outgassing detect at 85° C., such that the total organic carbon (TOC) detected by GC-MS is less than 30,000 ng/cm².

According to various embodiments the composite can exhibit in a low amount of leachable ions within a range having a lower limit and/or an upper limit. The range can include or exclude the lower limit and/or the upper limit.

The lower limit and/or upper limit can be selected from 5, 10, 15, 20, 25, 30, 35, 40, 45, 50, 55, 60, 65, 70, 75, 80, 85, 90, 95, and 100 ng/cm². For example, according to certain preferred embodiments, according to various embodiments the composite can exhibit in a low amount of leachable ions of less than 60 ng/cm².

According to various embodiments the composite has low non-volatile organic residue, such that the total organic carbon (TOC) detected by GC-MS within a range having a lower limit and/or an upper limit. The range can include or exclude the lower limit and/or the upper limit. The lower limit and/or upper limit can be selected from 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, and 350 ng/cm². For example, according to certain preferred embodiments, according to various embodiments the composite has low non-volatile organic residue, such that the total organic carbon (TOC) detected by GC-MS is less than 300 ng/cm².

The invention is further described in the following illustrative examples in which all parts and percentages are by weight unless otherwise indicated.

### EXAMPLES

Table 1 by the summary of materials employed according to the examples.

TABLE 1

| | CHEMICAL | SOURCE, |
|---|---|---|
| COMPONENT | DESCRIPTION | VENDOR |
| ULTEM ® 1010 | polyetherimide | SABIC |
| ULTEM ® 1040 | polyetherimide | SABIC |
| LCP A2500 | Wholly aromatic | UNEO Fine |
| | liquid crystal | Chemicals Industry, |
| | polyether resin | Ltd. |
| LCP A5000 | Wholly aromatic | UNEO Fine |
| | liquid crystal | Chemicals Industry, |
| | polyether resin | Ltd. |
| LC 5000 | Liquid Crystalline | Unitika Ltd, Japan |
| | Polymer | |
| | Rodrun LC-5000 | |
| Amodel PPA A1006 | Polyphthalamide | Solvay Advanced |
| | | Polymers, LLC. |
| ZYTEL HTN 501 | High temp Nylon | Dupont |
| PA66 Regular - NV | Polyamide 66 | BASF |
| PA6 Regular - NV HAEG | Polyamide 6 | BASF |
| OC GF | Glass fiber | Owens Corning |
| Glass flake REFG315 | Glass flake | Nippon sheet glass |
| Flat fiber 3PA-830 | Flat fiber | Nittobo |
| Flat fiber 3PA-820 | Flat fiber | Nittobo |
| NSG Fineflake | Fineflake | Nippon sheet glass |
| MEG160FYX coated | | |

### Techniques & Procedures

### Compounding and Molding:

The examples relate to polymer blends filled with mixed fillers of different ratios. All the ingredients were dry blended for 3-5 minutes in a super-floater except for the glass fiber. The resins were pre-dried at 150° C. for about 4 hours before extrusion. The glass fiber was fed at the down-stream with a side feeder. The blends were added at the throat. Formulations were compounded on a 37 mm Toshiba twin-screw with vacuum vented extruder at 340-360° C. barrel set temperature with 300-350 rpm and 50-60 kg/hr. After compounding, pellets were dried for 4-6 hours at 150=C and injection molded on a 110 ton Fanuc injection molding machine; ASTM bars and the application HDD parts were molded with barrel temperature setting at 340-360° C. and mold temperature 150° C. After being molded the application HDD parts were tested.

### Metallization Methods:

According to various embodiments, molded plastic plaques were washed by ultrasonic cleaner in pure water and baked at 120=C for 2 hours. Subsequently, the plastic plaques were treated by Oxygen Plasma in the chamber before sputtering. The desired metal film was fabricated by Ni sputtering method.

Flow coating can be employed. A polyetherimide (PEI) plaque with/without Ni metallization layer was fixed onto a mobile holder. Then the mobile holder moved with a track at a moving speed of 1-2 m/min. A coating liquid which came out from a nozzle flowed onto the surface of PEI plaque. Following that, the plaque was dried at 40° C. for 20 minutes to remove diluting agent completely, and was cured by high-pressure mercury lamp with UVA intensity at 250 mW/cm² and UV energy at 1000 mJ/cm². UV-cured products were collected and tested.

### Cleanness Testing Methods:

Dynamic Headspace Outgassing can be employed to measure the Volatile residue (DHS/out gassing) by GC-MS. The specimen was collecting under 85° C. for 3 hours with molded parts then detected by a dynamic head-space Gas Chromatograph/Mass Spectrometer (DHS-GCMS).

Non-volatile organic residue over the Non-volatile residue (NVR) can be measured on components by GC-MS which is analyzing the residue from solvent (Hexane) extraction and quantifying any C₁₈ to C₄₀ hydrocarbon, Irgafos, Irgafos oxidized, and cetyl esters of C₁₄, C₁₆, and C₁₈ fatty acids. This method includes the steps of testing parts that are soaked with 10 ml hexane for 10 minutes. 8 ml of solution is dried to remove the solvent, and then 1 mL hexane is added to resolubilize the solution. The solution is again dried and then 50 μL D10-Anthracene-2 ppm standards in methylene chloride are added. Total C₁₈-C₄₀Hydrocarbons (HC, refer to an organic compound that contains only carbon and hydrogen) and TOC are measured for target materials using a Gas Chromatograph/Mass Spectrometer (GCMS) with the injector temperature at 300° C.

Leachable Ionic residue can be measured. To measure the total ionic contamination and residue including fluoride, chloride, nitride, bromide, nitrate, phosphate, sulfate, and ammonium ions by ion chromatography (IC). The test specimen was rinsed by deionized (DI) water at 85° C. for 1 hour, and then tested by ion chromatography.

Liquid particle counting (LPC) can be employed to measure the amount of residual particles on components with ultrasonic extracting the particles. The system was combined with one PMS LPC, two Crest Custom 40 kHz & 68 kHz ultrasonic cleaners and one 100CLASS clean bench, which can measure from 300 nm to 2 μm residual particles on the part surface.

All the other tests are based on ASTM and ISO standard as shown in Table 2.

TABLE 2

| Test Name | Test Standard | Default Specimen Type | Units |
|---|---|---|---|
| ASTM | ASTM D790 | Bar - 127 × 12.7 × | MPa |
| Flexural | | 3.2 mm | |
| Test | | | |
| ASTM HDT | ASTM D648 | Bar - 127 × 12.7 × | ° C. |
| Test | | 3.2 mm | |
| ASTM HDT | ASTM D648 | Bar - 127 × 12.7 × | ° C. |
| Test | | 3.2 mm | |
| ASTM Filled | ASTM D638 | ASTM Type I Tensile bar | MPa |
| Tensile Test | | | |
| ASTM Izod | Notched | Bar - 63.5 × 12.7 × | J/m |
| at Room | ASTM D256 | 3.2 mm | |
| Temperature | | | |
| Shrinkage | GEP Method | Disk - 101.6 mm dia × | % |
| | | 3.2 mm thick | |
| Capillary | ASTM D3835 | Pellets | Pa · s |
| melt | | | |
| viscosity | | | |
| ASTM Melt | ASTM D1238 | Pellets | g/10 min |
| Flow Rate | | | |
| ISO | ISO 11359-2 | Multi-purpose ISO 3167 | μm/ |
| Coefficient | | Type A | (m · ° C.) |
| of Thermal | | | |
| Expansion | | | |

### Examples 1, 2-1.2-2, 2-3, and 2-4

In Examples 1, 2-1, 2-2, 2-3, and 2-4, the PPA as a flow promoter was introduced into the glass filled PEI system with different filler types. Various types of stability were tested and studied, including but not limited to: mechanical, heat, impact, and thermal stability. The results are summarized in Table 3. Example 1 is a reference example and Examples 2-1, 2-2, 2-3, and 2-4 exemplify embodiments or our invention.

TABLE 3

| | Example | | | | |
|---|---|---|---|---|---|
| | 1 | | | | |
| Components | (Reference) | 2-1 | 2-2 | 2-3 | 2-4 |
| ULTEM ® 1010 (wt. %) | 70 | 66 | 66 | 66 | 30 |
| ULTEM ® 1040 (wt. %) | | | | | 36 |
| Amodel PPA A1006 (wt. %) | | 4 | 4 | 4 | 4 |
| OC GF (wt. %) | 30 | 30 | | | 30 |
| Glass flake REFG315 (wt. %) | | | 30 | | |
| Flat fiber 3PA-830 (wt. %) | | | | 30 | |
| Standard performance | | | | | |
| MFR, 337° C./6.6 kgf (g/10 min) | 5 | 16.9 | 17.2 | 16.8 | 25.3 |
| Flex Modulus, 2.6 mm/min, 100 mm span (MPa) | 8950 | 9310 | 7350 | 9310 | 9060 |
| Flex str, yld, 2.6 mm/min, 100 mm span (MPa) | 225 | 266 | 162 | 233 | 236 |
| Ten Modulus, 5 mm · min (MPa) | 9300 | 10235.8 | 8059.6 | 10553.2 | 1010.3 |
| Ten Str (SG), brk, 5 mm/min (MPa) | 158 | 184.8 | 96.8 | 169.2 | 182.6 |
| HDT, 1.82 MPa, 3.2 mm (° C.) | 207 | 203 | 197 | 202 | 200 |
| Notched Impact, 23° C. (J/m) | 82 | 73.3 | 37.9 | 77 | 76.1 |
| Viscosity at 5000 1/s, at 360° C. (Pa · s) | 272 | 133.47 | 141.49 | 129.76 | 114.66 |
| CTE, flow (μm/(m · ° C.)) | 23.4 | 22.64 | 17.46 | 16.72 | 24.61 |
| CTE, x-flow (μm/(m · ° C.)) | 58.2 | 55.17 | 50.62 | 60.56 | 52.49 |
| Shrinkage, flow (%) | 0.35 | 0.39 | 0.32 | 0.33 | 0.34 |
| Shrinkage, x-flow (%) | 0.4 | 0.44 | 0.32 | 0.32 | 0.39 |
| Warpage in Jamaica design top cover (mm) | 0.826 | 1.908 | 0.144 | 0.363 | 0.924 |
| Standard performance | | | | | |
| Second process, plating and coating | none | none | none | none | none |
| Outgassing, molded part (ng/cm²) | 35.8 | 10.4 | 19.3 | 17.1 | 32.8 |
| Leachable IC, total ion (ng/cm²) | 23.8 | 17.1 | 26.6 | 21.9 | 11.8 |
| NVR, total TOC (ng/cm²) | 66.2 | 89.2 | 112.9 | 84.5 | 106.2 |

Example 1 is a reference Example regarded as standard chopped glass reinforced polyetherimide composites, commercial name ULTEM® 2310. The example showed balanced mechanical, heat, and impact properties. The cleanliness test showed it contains very low outgassing, leachable ions, and organic residues, rendering Example 1a good candidate for HDD application. However, the flowability of Example 1 was not good enough. The melt viscosity at 5000 1/s at 360° C. was 272 Pa·s, which is not suitable for a thin wall HDD cover application which required 0.4-0.8 mm thickness top cover. Additionally, the warpage of the molded part was large, at 0.826 mm.

In the Example 2-1, 4 wt. % PPA was introduced into the formulation of Example 1. The flowability was significantly improved with capillary viscosity reduced from 272 to 133.47 Pa·s. While the other mechanical, heat, impact property and cleanliness were well maintained. However, the warpage of the molded part increased to 1.908 mm. Example 2-1 is a failure example due to the warpage performance obtained.

In the Example 2-2, the filler was changed from standard chopped glass to glass flake with PPA as a flow promoter. The flowability of Example 2-2 was also improved compared with Example 1 by looking at the melt viscosity data. In the presence of the glass flake, the thermal dimensional stability (CTE) and shrinkage of the Example 2-2 was well improved compared with the standard chopped glass. The warpage of the molded part was controlled to a very low level at 0.144 mm. The cleanliness performance was also very good. However, in the presence of glass flake, the mechanical, heat and impact properties were less than that of the standard chopped glass version. Example 2-2 is a failure example due to poor mechanical, heat and impact properties.

In the Example 2-3, the filler of flat fiber was used to build the formulation. The balanced performance including the mechanical, heat, impact, cleanliness performance was observed. The flowability of the composites with 4% PPA and flat fiber was improved. The thermal dimensional stability, shrinkage was improved compared with Example 1. Although the warpage was improved significantly with respect to Example 1, Example 2-3 is still a failure example due to the poor warpage performance.

In the Example 2-4, half polyetherimide resin was changed to high flow version ULTEM® 1040 based on the Example 2-1. The similar performance of Example 2-4 was observed with that of the Example 2-1. The melt viscosity of Example 2-4 was further improved to 114.66 Pa·s with excellent mechanical, heat, impact, and cleanliness properties, although the warpage of the Example 2-4 was beyond the specification. Thus, Example 2-4 was a failure example due to the poor warpage.

### Examples 3-1, 3-2, and 3-3

In Examples 3-1, 3-2, and 3-3, the liquid crystal polymer as a flow promoter was introduced into the glass filled PEI system with different filler types. Various types of stability were tested and studied, including but not limited to: mechanical, heat, impact, and thermal stability. The results are summarized in Table 4. Examples 3-1, 3-2, 3-3 exemplify embodiments or our invention.

TABLE 4

| | Example | | |
|---|---|---|---|
| Components | 3-1 | 3-2 | 3-3 |
| ULTEM 1010 (wt. %) | 25 | 25 | 25 |
| ULTEM 1040 (wt. %) | 30 | 30 | 30 |
| UENO LCP A2500 (wt. %) | 15 | 15 | 15 |
| OC GF (wt. %) | 30 | | |
| Glass flake REFG315 (wt. %) | | 30 | |
| Flat fiber 3PA-830 (wt. %) | | | 30 |
| Standard performance | | | |
| MFR, 337° C./6.6 kgf (g/10 min) | 28 | 127 | 32.7 |
| Flex Modulus, 2.6 mm/min, 100 | 9430 | 8680 | 10200 |
| mm span (MPa) | | | |
| Flex str, yld, 2.6 mm/min, 100 | 204 | 115 | 171 |
| mm span (MPa) | | | |
| Ten Modulus, 5 mm · min (MPa) | 11937 | 9114.2 | 11936.4 |
| Ten Str (SG), brk, 5 mm/min (MPa) | 142 | 72.4 | 131 |
| HDT, 1.82 MPa, 3.2 mm (° C.) | 203 | 202 | 206 |
| Notched Impact, 23° C. (J/m) | 85.6 | 33.1 | 90 |
| Viscosity at 5000 1/s, at 360° C. | 68.15 | 51.45 | 67.02 |
| (Pa · s) | | | |
| CTE, flow (μm/(m · ° C.)) | 23.18 | 19.26 | 13.42 |
| CTE, x-flow (μm/(m · ° C.)) | 53.87 | 49.72 | 50.78 |
| Shrinkage, flow (%) | 0.31 | 0.31 | 0.27 |
| Shrinkage, x-flow (%) | 0.42 | 0.3 | 0.34 |
| Warpage in Jamaica design top | 5.049 | 0.244 | 3.011 |
| cover (mm) | | | |
| Standard performance | | | |
| Second process, plating and coating | none | none | none |
| Outgassing, molded part (ng/cm²) | 41.7 | 20.6 | 21 |
| Leachable IC, total ion (ng/cm²) | 18.4 | 11.8 | 12.4 |
| NVR, total TOC (ng/cm²) | 244.9 | 124.4 | 126.8 |

In Example 3-1, 15 wt. % LCP was introduced into the 30 wt. % standard chopped glass filled polyetherimide composites. The flowability was significantly improved with melt viscosity was lower to 41.7 Pa·s. While the other mechanical, heat, impact property and cleanliness were well maintained. The warpage of the molded part was enhanced, however and rendered Example 3-1 a failure example.

In Example 3-2, the filler was changed from standard chopped glass to glass flake based on the Example 3-1 with 15% LCP as the flow promoter. The flowability of Example 3-2 was also improved compared with Example 1 by looking at the melt viscosity data. In the presence of the glass flake, the thermal dimensional stability (CTE) and shrinkage of the Example 3-2 was well improved compared with the standard chopped glass. The warpage of the molded part was controlled in a very low level at 0.244 mm. The cleanliness performance was also very good. However, in the presence of glass flake, the mechanical, heat and impact properties decreased relative to that of the standard chopped glass version. Example 3-2 is a failure example due to poor mechanical, heat and impact properties.

In Example 3-3, the filler of flat fiber was used to build the formulation. The balanced performance including the mechanical, heat, impact, cleanliness performance was observed. The flowability of the composites with 15% LCP and flat fiber was improved. The thermal dimensional stability, shrinkage was improved compared with Example 1. Example 3-3 is still a failure example due to the poor warpage performance.

### Examples 4-1 and 4-2

In Examples 4-1 and 4-2, the filler system was built by the combination of flat fiber and glass flake. The flow promoter of PPA and LCP was also introduced. Various types of stability were tested and studied, including but not limited to: mechanical, heat, impact, and thermal stability. The results are summarized in Table 5. Examples 4-1 and 4-2 exemplify embodiments or our invention.

TABLE 5

| | Example | |
|---|---|---|
| Components | 4-1 | 4-2 |
| ULTEM 1010 (wt. %) | 66 | 25 |
| ULTEM 1040 (wt. %) | | 30 |
| UENO LCP A2500 (wt. %) | | 15 |
| Amodel PPA A1006 (wt. %) | 4 | |
| Glass flake REFG315 (wt. %) | 10 | 10 |
| Flat fiber 3PA-830 (wt. %) | 20 | 20 |
| Standard performance | | |
| MFR, 337° C./6.6 kgf (g/10 min) | 16.1 | 46 |
| Flex Modulus, 2.6 mm/min, 100 mm span (MPa) | 9030 | 9930 |
| Flex str, yld, 2.6 mm/min, 100 mm span (MPa) | 218 | 177 |
| Ten Modulus, 5 mm · min (MPa) | 9897.8 | 11347.6 |
| Ten Str (SG), brk, 5 mm/min (MPa) | 148.6 | 119.6 |
| HDT, 182 MPa, 3.2 mm (° C.) | 202 | 205 |
| Notched Impact, 23° C. (J/m) | 55 | 72.7 |
| Viscosity at 5000 1/s, at 360° C. (Pa · s) | 128.87 | 55.74 |
| CTE, flow (μm/(m · ° C.)) | 19.62 | 15.45 |
| CTE, x-flow (μm/(m · ° C.)) | 50.85 | 45.69 |
| Shrinkage, flow (%) | 0.34 | 0.32 |
| Shrinkage, x-flow (%) | 0.38 | 0.29 |
| Warpage in Jamaica design top cover (mm) | 0.204 | 0.325 |
| Standard performance | | |
| Second process, plating and coating | none | none |
| Outgassing, molded part (ng/cm²) | 34.5 | 49.1 |
| Leachable IC, total ion (ng/cm²) | 25.4 | 28.3 |
| NVR, total TOC (ng/cm²) | 121.9 | 144.7 |

Example 4-1 is an inventive example, with 4% PPA as the flow promoter, the filler system contained 10% glass flake and 20% flat fiber. The melt viscosity was reduced to 128.87 Pa·s compared to that of the Example 1. The mechanical, heat, impact and cleanliness performance was well-balanced. The thermal dimensional stability (CTE), shrinkage, warpage was controlled to a very low level which was able to meet the HDD cover application.

Example 4-2 is also an inventive example, with 15% LCP as the flow promoter, the filler system contained 10% glass flake and 20% flat fiber. The melt viscosity was reduced to 55.74 Pa·s compared to that of the Example 1. The mechanical, heat, impact and cleanliness performance was also well-balanced.

The thermal dimensional stability (CTE), shrinkage, warpage was controlled to a very low level, which was able to meet the HDD cover application.

### Examples 5-1, 5-2, 5-3, 5-4, and 5-5

In Examples 5-1, 5-2, 5-3, 5-4, and 5-5, the formulations were 40% filled in the presence of 4% PPA as the flow promoter. The glass system was a combination of 30% flat fiber and 10% glass flake. Various types of stability were tested and studied, including but not limited to: mechanical, heat, impact, and thermal stability. Furthermore the secondary metallization and polymeric coating was undertaken on the molded part to evaluate the cleanliness performance. The results are summarized in Tables 6 A and 6 B. Examples 5-1, 5-2, 5-3, 5-4, and 5-5 exemplify embodiments or our invention.

TABLE 6 A

| | Example | | |
|---|---|---|---|
| Components | 5-1 | 5-2 | 5-3 |
| ULTEM 1010 (wt. %) | 56 | 56 | 56 |
| Amodel PPA A1006 (wt. %) | 4 | 4 | 4 |
| Flat fiber 3PA-820 (wt. %) | 30 | 30 | 30 |
| NSG Fineflake MEG160FYX | 10 | 10 | 10 |
| coated (wt. %) | | | |
| Standard performance | | | |
| MFR, 337° C./6.6 kgf (g/10 min) | 12.9 | | |
| Flex Modulus, 2.6 mm/min, 100 | 11200 | | |
| mm span (MPa) | | | |
| Flex str, yld, 2.6 mm/min, 100 | 252 | | |
| mm span (MPa) | | | |
| Ten Modulus, 5 mm · min (MPa) | 13624.8 | | |
| Ten Str (SG), brk, 5 mm/min (MPa) | 188.6 | | |
| HDT, 1.82 MPa, 3.2 mm (° C.) | 206 | | |
| Notched Impact 23° C. (J/m) | 79.2 | | |
| Viscosity at 5000 1/s, at 360° C. | 135.57 | | |
| (Pa · s) | | | |
| CTE, flow (μm/(m · ° C.)) | 14.86 | | |
| CTE, x-flow (μm/(m · ° C.)) | 37.55 | | |
| Shrinkage, flow (%) | 0.16 | | |
| Shrinkage, x-flow (%) | 0.24 | | |
| Warpage in Jamaica design top | 0.142 | | |
| cover (mm) | | | |
| Standard performance | | | |
| Second process, plating and coating | | Sputtering | Acrylate |
| | | Ni 200 nm | coating |
| | | | 5 μm |
| Outgassing, molded part (ng/cm²) | 71 | 9.8 | 9.1 |
| Leachable IC, total ion (ng/cm²) | 46.2 | 26.5 | 36.7 |
| NVR, total TOC (ng/cm²) | 158.984 | 7.79 | 2.24 |
| LPC at 5 times extraction | 6116 | 1360 | 933 |
| (particles/cm²) | | | |

TABLE 6 B

| | Example | |
|---|---|---|
| Components | 5-4 | 5-5 |
| ULTEM 1010 (wt. %) | 56 | 56 |
| Amodel PPA A1006 (wt. %) | 4 | 4 |
| Flat fiber 3PA-820 (wt. %) | 30 | 30 |
| NSG Fineflake MEG160FYX | 10 | 10 |
| coated (wt. %) | | |
| Second process, plating | Sputtering Ni | Sputtering Ni |
| and coating | 200 nm (up) + | 200 nm (down) + |
| | Acrylate coating | Acrylate coating |
| | 5 μm (down) | 5 μm (up) |
| Outgassing, molded part (ng/cm²) | 11.6 | 21.3 |
| Leachable IC, total ion (ng/cm²) | 18.1 | 32 |
| NVR, total TOC (ng/cm²) | 2.28 | 3.21 |
| LPC at 5 times extraction | 1120 | 470 |
| (particles/cm²) | | |

Example 5-1 is an inventive example, with 4% PPA as the flow promoter, the filler system contained 10% glass flake and 30% flat fiber. The melt viscosity at 5000 1/s and 360° C. was 135.57 Pa·s, the flowability was excellent for thin wall molding. The mechanical, heat, impact performance was well balanced. And the thermal dimensional stability (CTE), shrinkage, warpage was achieved to a low level which was able to meet the HDD cover application. By looking at the cleanliness performance, although the outgassing, leachable ion chromatography (IC), organic residues, liquid particle counter was good for the application, it can be further improved by secondary process such as metallization and polymeric coating on the plastic surface as cover effect.

Example 5-2 is an inventive example, with 200 nm Ni plating layer on the plastic substrate based on the Example 5-1 formulation. The cleanliness results showed the outgassing, leachable ions, organic residues was remarkable reduced compared with the Example 5-1. The liquid particle counter was reduced from 6116 of Example 5-1 to 1360.

Example 5-3 is an inventive example, with 5 μm acrylate polymer coating layer on the plastic substrate based on the Example 5-1 formulation. The cleanliness results showed the outgassing, leachable ions, organic residues was remarkable reduced compared with the Example 5-1. Additionally, the liquid particle count (LPC) was reduced from 6116 of Example 5-1 to 933.

Example 5-4 is an inventive example, with 200 nm Ni plating layer (up layer) and 5 μm acrylate polymer coating layer (down layer) on the plastic substrate based on Example 5-1 formulation. The cleanliness results showed the outgassing, leachable ions, organic residues was remarkable reduced compared with Example 5-1. The liquid particle count (LPC) was reduced from 6116 of Example 5-1 to 1120.

Example 5-5 is an inventive example, with 5 μm acrylate polymer coating layer (up layer) and 200 nm Ni plating layer (down layer) on the plastic substrate based on the Example 5-1 formulation. The cleanliness results showed the outgassing, leachable ions, organic residues was remarkable reduced compared with the Example 5-1. The liquid particle count (LPC) was reduced from 6116 of Example 5-1 to 470.

### Examples 6-1, 6-2, and 6-3

In Examples 6-1, 6-2, and 6-3, the formulations were 40% filled in the presence of 4% different type polyamides as the flow promoter. The glass system was a combination of 30% flat fiber and 10% glass flake. Various types of stability were tested and studied, including but not limited to: mechanical, heat, impact, and thermal stability. The results are summarized in Table 7. Example 6-1 exemplifies an embodiment or our invention. Example 6-2 does not exemplify an embodiment or our invention and is a failure. Example 6-3 exemplifies an embodiment or our invention.

TABLE 7

| | Example | | |
|---|---|---|---|
| Components | 6-1 | 6-2 | 6-3 |
| ULTEM 1010 (wt. %) | 56 | 56 | 56 |
| Flat fiber 3PA-820 (wt. %) | 30 | 30 | 30 |
| NSG Fineflake MEG160FYX | 10 | 10 | 10 |
| coated (wt. %) | | | |
| ZYTEL HTN 501 (wt. %) | 4 | | |
| PA66 Regular - NV (wt. %) | | 4 | |
| PA6 Regular - NV HAEG (wt. %) | | | 4 |
| MFR, 337° C./6.6 kgf (g/10 min) | 12.8 | 28.2 | 29.2 |
| Flex Modulus, 2.6 mm/min, | 10500 | X | 10400 |
| 100 mm span (MPa) | | | |
| Flex str, yld, 2.6 mm/min, | 226 | X | 207 |
| 100 mm span (MPa) | | | |
| Ten Modulus, 5 mm · min (MPa) | 12928.8 | X | 13198 |
| Ten Str (SG), brk, 5 mm/min (MPa) | 159.6 | X | 173.4 |
| HDT, 1.82 MPa, 3.2 mm (° C.) | 205 | X | 200 |
| Notched Impact, 23° C. (J/m) | 54.6 | X | 57 |
| Viscosity at 5000 1/s, at 380° C. | 136.85 | 41.39 | 54.32 |
| (Pa · s) | | | |
| CTE, flow (μm/(m · ° C.)) | 15.45 | | 16.09 |
| CTE, x-flow (μm/(m · ° C.)) | 37.46 | | 39.3 |
| Shrinkage, flow (%) | 0.18 | X | 0.17 |
| Shrinkage, x-flow (%) | 0.34 | X | 0.35 |
| Warpage in Jamaica design top | 0.143 | | 0.179 |
| cover (mm) | | | |

Example 6-1 is an inventive example, with 4% HTN as the flow promoter, the filler system contained 10% glass flake and 30% flat fiber. The melt viscosity at 5000 1/s and 360° C. was 136.85 Pa·s, the flowability was excellent for thin wall molding. The mechanical, heat, impact and cleanliness performance was well-balanced. The thermal dimensional stability (CTE), shrinkage, warpage was achieved to a low level, which was able to meet the HDD cover application.

Example 6-2 is a failure example with 4% polyamide-66 as the flow promoter, the filler system contained 10% glass flake and 30% flat fiber. Example 6-2 was not processable during the compounding due to the occurrence of polymer degradation.

Example 6-3 is an inventive example, with 4% polyamide-6 as the flow promoter, the filler system contained 10% glass flake and 30% flat fiber. The melt viscosity at 5000 1/s and 360° C. was 54.32 Pa·s, the flowability was excellent for thin wall molding. The mechanical, heat, impact and cleanliness performance was well balanced. The thermal dimensional stability (CTE), shrinkage, warpage was achieved to a low level which was able to meet the HDD cover application.

### Example 7-1, 7-2, and 7-3

In Examples 7-1, 7-2, and 7-3, the formulations were 40% filled in the presence of 10% different types of liquid crystal polymer as the flow promoter. The glass system was a combination of 30% flat fiber and 10% glass flake. Various types of stability were tested and studied, including but not limited to: mechanical, heat, impact, and thermal stability. Examples 7-1, 7-2, and 7-3 exemplify embodiments or our invention.

TABLE 8

| | Example | | |
|---|---|---|---|
| Components | 7-1 | 7-2 | 7-3 |
| ULTEM 1010 (wt. %) | 50 | 50 | 50 |
| UENO LCP A2500 (wt. %) | 10 | | |
| Flat fiber 3PA-820 (wt. %) | 30 | 30 | 30 |
| NSG Fineflake MEG160FYX | 10 | 10 | 10 |
| coated (wt. %) | | | |
| UENO LCP A5000 (wt. %) | | 10 | |
| Rodrun LCP LC 5000 (wt. %) | | | 10 |
| Standard performance | | | |
| MFR, 337° C./6.6 kgf (g/10 min) | 7.02 | 7.78 | 8.83 |
| Flex Modulus, 2.6 mm/min, | 10500 | 11000 | 11100 |
| 100 mm span (MPa) | | | |
| Flex str, yld, 2.6 mm/min, | 169 | 202 | 198 |
| 100 mm span (MPa) | | | |
| Ten Modulus, 5 mm · min (MPa) | 13005.6 | 13612 | 13670.2 |
| Ten Str (SG), brk, 5 mm/min (MPa) | 117.8 | 144.8 | 134 |
| HDT, 1.82 MPa, 3.2 mm (° C.) | 208 | 203 | 203 |
| Notched Impact, 23° C. (J/m) | 63.7 | 64 | 61.1 |
| Viscosity at 5000 1/s, at 360° C. | 86.43 | 119.79 | 96.95 |
| (Pa · s) | | | |
| CTE, flow (μm/(m · ° C.)) | 14.35 | 14.15 | 13.74 |
| CTE, x-flow (μm/(m · ° C.)) | 42.01 | 41.02 | 42.34 |
| Shrinkage, flow (%) | 0.18 | 0.2 | 0.18 |
| Shrinkage, x-flow (%) | 0.3 | 0.32 | 0.31 |
| Warpage in Jamaica design top | 0.263 | 0.204 | 0.245 |
| cover (mm) | | | |

Example 7-1 is an inventive example, with 10% UENO A2500 LCP as the flow promoter, the filler system contained 10% glass flake and 30% flat fiber. The melt viscosity at 5000 1/s and 360° C. was 86.43 Pa·s, the flowability was excellent for thin wall molding. The mechanical, heat, impact and cleanliness performance was well balanced. The thermal dimensional stability (CTE), shrinkage, warpage was achieved to a low level which was able to meet the HDD cover application.

Example 7-2 is an inventive example, with 10% UENO A5000 LCP as the flow promoter, the filler system contained 10% glass flake and 30% flat fiber. The melt viscosity at 5000 1/s and 360° C. was 119.79 Pa·s, the flowability was excellent for thin wall molding. The mechanical, heat, impact and cleanliness performance was well balanced. The thermal dimensional stability (CTE), shrinkage, warpage was achieved to a low level which was able to meet the HDD cover application.

Example 7-3 is an inventive example, with 10% Rodrun LCP as the flow promoter, the filler system contained 10% glass flake and 30% flat fiber. The melt viscosity at 5000 1/s and 360° C. was 96.95 Pa·s, the flowability was excellent for thin wall molding. The mechanical, heat, impact and cleanliness performance was well balanced. The thermal dimensional stability (CTE), shrinkage, warpage was achieved to a low level, which was able to meet the HDD cover application.

Although the present invention has been described in considerable detail with reference to certain preferred versions thereof, other versions are possible. Therefore, the spirit and scope of the appended claims should not be limited to the description of the preferred versions contained herein.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C §112, sixth paragraph. In particular, the use of “step of” in the claims herein is not intended to invoke the provisions of 35 U.S.C §112, sixth paragraph.

1. A filled polymeric composition of high flowability suitable for thin wall (<1 mm thickness) molding comprising:
(a) from 10 to 50 wt % of a reinforcing filler;
(b) a flow promoter component selected from the group consisting of from 1 to 10 wt % of a polyamide,
from 5 to 20 wt % of a liquid crystal polymer (LCP), and combinations thereof; and
the balance being a polyetherimide (PEI) resin.

2. The composition of claim 1, wherein the composition exhibits a linear flow during injection molding and a capillary viscosity of at least 25% lower than a reinforced polyimide resin without components (b) and (c), and lower than 150 pa·s at 5000 l/s shear rate at 360° C.

3. The composition of claim 1, wherein the reinforcing filler is one selected from the group consisting of glass fiber, glass flake, flat glass fiber, and combinations thereof.

4. The composition of claim 1, wherein the polyamide flow promoter is one selected from the group consisting of nylon 6, nylon 66, polyphthalamide, and combinations thereof.

5. The composition of claim 1, wherein the liquid crystal polymer comprises a high-melting point thermoplastic selected from the group consisting of co-polyester, co-polyesteramides, multiple half or wholly aromatic polyesters and combinations thereof.

6. The composition of claim 1, wherein the composition has an heat distortion temperature (HDT) higher than 180° C.

7. The composition of claim 1, wherein the flexure modulus is higher than 8,000 MP; the tensile strength is higher than 100 MPa; and the notched impact is higher than 50 J/m.

8. A composite comprising: an injection molded substrate having a thickness of 0.4-0.8 mm, formed of the composition of claim 1, and at least one coating thereon, the coating selected from the group consisting of a metal and an acrylate coating.

9. The composite of claim 8, comprising both an acrylate coating and a metal coating.

10. The composite of claim 9, wherein the acrylate coating lies between the substrate and the metal.

11. The composite of claim 9, wherein the metal coating lies between the substrate and the acrylate coating.

12. The composite of claim 8, wherein the metal is Ni.

13. The composite of claim 8, wherein the metal is a sputtered metal.

14. The composite of claim 8, wherein the liquid particle counter value is less than 1,500 particles/cm2.

15. The composite of claim 8, wherein the composite is in the form of an HDD enclosure.

16. The composite of claim 15, wherein the warpage is lower than 350 μm on a top cover of the IIDD enclosure.

17. The composite of claim 8, wherein the composite is a disk drive enclosure enclosing at least one surface of the disk.

18. The composite of claim 8, wherein the composite has an outgassing detection at 85° C., showing a total organic carbon (TOC) content of less than 30,000 ng/cm2.

19. The composite of claim 8, exhibiting a leachable ion content of less than 60 ng/cm2.

20. The composite of claim 8, having a non-volatile organic residue detected by GC-MS, showing a total organic carbon (TOC) content of less than 300 ng/cm2.
